(19) United States
(12) Patent Application Publication
(10) Pub. No.: US 2008/0223199 A1
(43) Pub. Date: Sep. 18, 2008

(54) Instant Rehearseless Conducting

(76) Inventor: Manfred Clynes, Sonoma, CA (US)

Correspondence Address: HOLLAND & KNIGHT LLP, 10 ST. JAMES AVENUE, 11th Floor, BOSTON, MA, 02116-3889, US

(21) Appl. No.: 11/687,211

(22) Filed: Mar. 16, 2007

(51) Int. Cl. G10H 7/00

(52) U.S. Cl. 84/609

(57) ABSTRACT

A method includes receiving digital inputs from a joystick linked to a computer causing affects to music generated from a first music file, and storing the affected generated music in a second music file. The digital inputs can include movements resulting positioning the joystick.

### BACKGROUND

The present invention relates to instant rehearseless conducting.

In the field of music, the art of conducting with symphony orchestras includes a conductor watched visually by a considerable number of musicians, which enables the conductor's interpretation of music to become realized by the group as they play.

Computers can play music saved in a variety of audio file formats but the interpretation of the movements have not been be accomplished by the computer in a musical way.

### SUMMARY

The present invention provides methods and apparatus, including computer program products, for instant rehearseless conducting.

In an aspect, the invention features a method includes conducting music generated by a computer with a joystick.

In embodiments, the conducting includes receiving digital inputs from the joystick causing affects to the generated music, and storing the affected generated music.

The digital inputs can include movements resulting positioning the joystick. The movements can include up and down movements of the joystick controlling instant tempo over a particular range, and left and right movements of the joystick controlling instant loudness. The movements can include angled movements of the joystick controlling tempo change and loudness change. The angled movements of the joystick can include an upward left movement of the joystick producing faster and louder music, and a downward right movement of the joystick producing slower softer music. The movements can include a short jab of the joystick to an upper right region producing an acceleration of the music. The movements can include a fast retrieval of the joystick near a previous position controlling an accent produced on a note due to a louder portion of this transient. The movements can include angled movements controlling accent of the music.

Storing the affected generated music can include storing in an audio file. The audio file can be selected from the group consisting of a Waveform audio format (WAV) file, a Musical Instrument Digital Interface (MIDI) file and a Superconductor (MSC) file.

### BRIEF DESCRIPTION OF THE DRAWINGS

FIG. 1 is block diagram of a computer system.

FIG. 2 is a block diagram of an exemplary joystick.

FIG. 3 is a flow diagram of an instant rehearseless conducting process.

Like reference numbers and designations in the various drawings indicate like elements.

### DETAILED DESCRIPTION

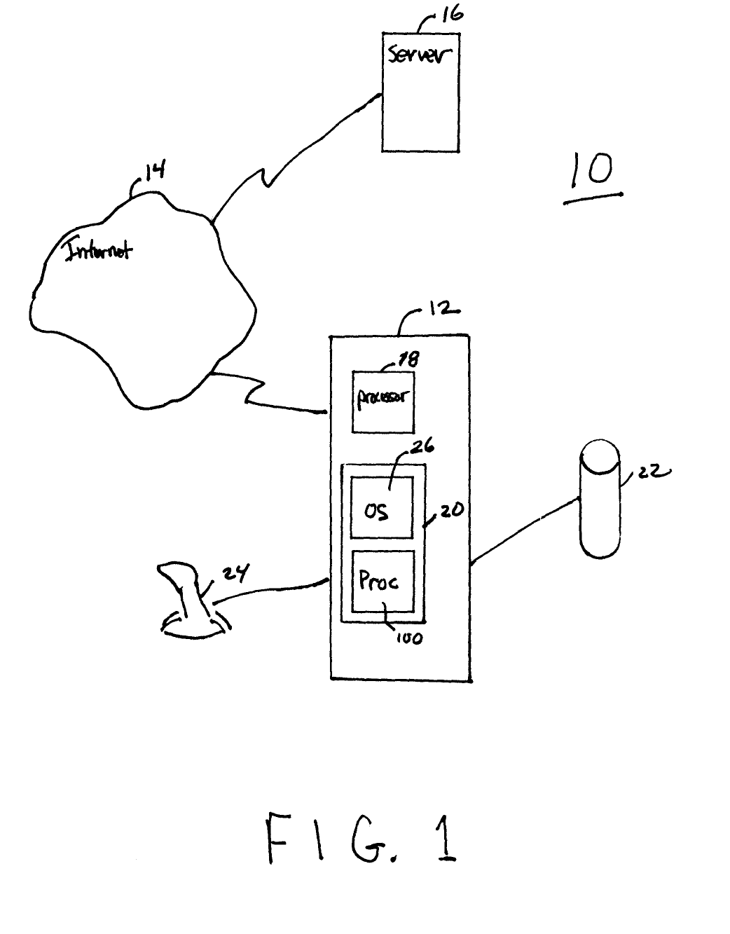

As shown in FIG. 1, a system 10 includes a computer 12 linked to a global network of interconnected computers 14, i.e., the Internet. The system 10 includes a server 16 linked to the Internet 14, which can be accessed by computer 12 and any other computer system linked to the Internet 14.

The computer 12 includes, for example, a processor 18, a memory 20, a storage device 22 and joystick 24. Memory 20 includes an operating system 26, such as Linux or Windows, and an instant rehearseless conducting process 100.

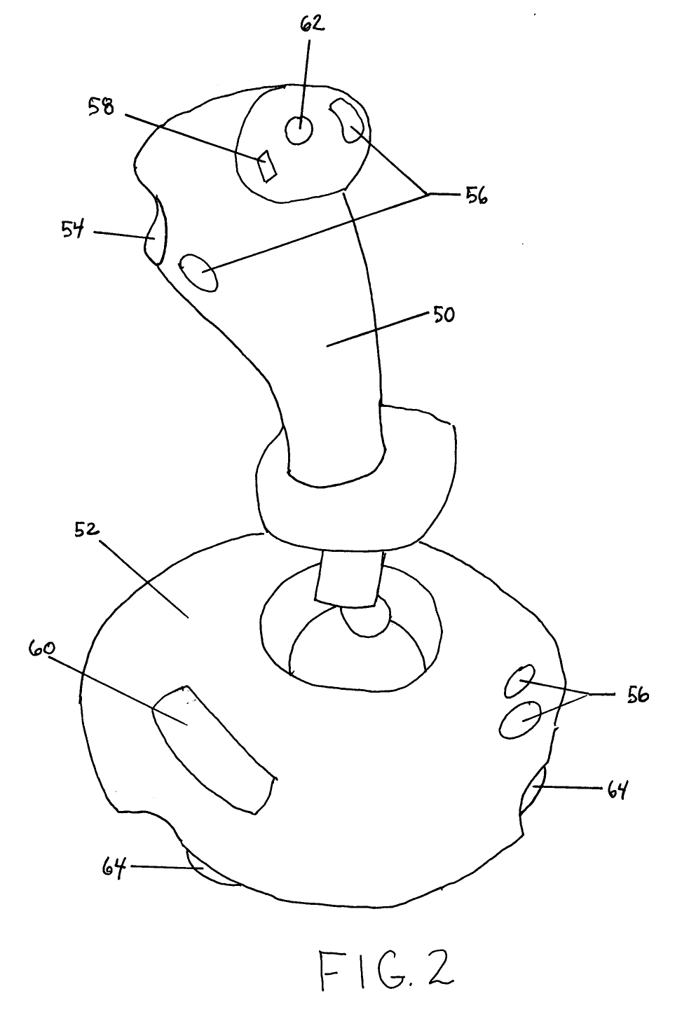

As shown in FIG. 2, the joystick 24 is a general control device typically including a handheld stick that pivots about one end and transmits its angle in two or three dimensions to the computer 12. Most joysticks are two-dimensional, having two axes of movement (similar to a mouse), but three-dimensional joysticks do exist. The joystick 24 is generally configured so that moving the stick left or right signals movement along the X-axis, and moving it forward (up) or back (down) signals movement along the Y-axis. In joysticks that are configured for three-dimensional movement, twisting the stick left (counter-clockwise) or right (clockwise) signals movement along the Z-axis. These axes are, in relation to an aircraft, roll, pitch, and yaw.

More specifically, the joystick 24 may include, for example, a stick 50, a base 52, and a trigger 54. In specific examples, the joystick 24 may include extra buttons 56, an autofire switch 58, a throttle 60, a hat switch 62 and/or a suction cup 64.

An analog joystick is a joystick that has continuous states, i.e., returns an angle measure of the movement in any direction in the plane or the space (usually utilizing potentiometers) and a digital joystick gives only on/off signals for four different directions, and mechanically possible combinations (such as up-right, down-left, and so forth).

Joysticks are often used to control games, and usually have one or more push-buttons whose state can also be read by the computer. Most input/output (I/O) interface cards for computers have a joystick (game control) port. Joysticks often use a Universal Serial Bus (USB) interface for connection to the computer system.

Herein, the joystick 24 is used to conduct music generated from the computer 12.

The art of conducting music can include many functions. For example, when conducting, a conductor waves his arms, often with the help of a baton indicating a beat and its variations as the music progresses in time. One function of the conductor is to ensure that the musicians pay together with as high a degree of precision as possible. To ensure precision, the conductor needs to have a clear, good beat, one that is relatively easy to follow visually by the musicians in an orchestra.

The beat also differs whether the music is in 4/4 time, or 3/4 time, or other variant of meter. To ensure initial playing together, a particularly good initial down beat is desirable and made clearer by an anticipatory upbeat, and similarly at especially crucial moments of the music, where without a clear beat, musicians would not know how to coordinate their various parts.

In one example, the conductor can stop conducting for a while and let the orchestra play by itself, in suitable places of the music, and the orchestra allowed to simply play by itself, propelled by the music. Such moments can be quite magical. Such maneuvers are exceptional however and quite rare. A large portion of the efforts of a conductor are expended on ensuring the precision of the group playing together.

A second conductor function is to ensure that musicians who often have extended rests come in at the right time when their moment of playing arrives. This function is sometimes referred to as “giving the necessary cues” to particular musicians or groups of musician to enter. This function is often carried out by the left hand and arm of right-handed conductors.

A third conductor function is to provide flexibility of the beat, i.e., to mark the slow downs and speed ups of the music where the conductor deems it necessary. Resolution of this ability is determined by a rate of the beat, on the order of approximately 0.5 to 1.0, for example. As the beat slows down or accelerates, it takes an appreciable fraction of the beat for the intention of the conductor to be perceived by musicians. Moreover, it is often assumed that the musicians perceive this with their own equal resolution of spatial-temporal perception, or the speeding up or slowing down of the beat would cause the musicians to lose their synchronous performance. The tempo flexibility is therefore limited by production of the beat by the conductor and the perception of the subtleties of the beat by the musicians, many of whom often do not watch the conductor too well.

Conducting does not easily permit intimate effects to be transmitted appropriately, i.e., effects requiring immediacy in the moment.

In addition to the above functions, the conductor needs to indicate loudness and changes in loudness as the musicians play, differently from different players and sections of the orchestra. This can be accomplished in various ways, such as by visual amplification of the size of the beats, by the posture of the conductor, and by special gestures to single players or to sections, done with the left hand and through a combination of all of these.

The instant rehearseless conducting process 100 provides an intimacy and immediacy only possible by a highly skilled instrumentalist on a single instrument, and accomplishes this without requiring any skill of performing any instrument at all. Instant rehearseless conducting process 100 is an immediate access to the heart of music, for the young and old and performs without rehearsal.

The instant rehearseless conducting process 100 enables the differently important remaining aspects of the conductor's efforts to be well executed, better in fact than conductors can readily accomplish.

The instant rehearseless conducting process 100 makes crescendos and diminuendos with millisecond resolution and almost instant response; it can accelerate or slow down even a single note even after it has begun, without affecting the sonic quality.

The instant rehearseless conducting process 100 can shape the ending of notes as desired, and even introduce a desired degree of tremolo for the entire orchestra together, on certain notes or short sections with full control of the tremolo.

The instant rehearseless conducting process 100 uses joystick 24 connected to, for example, a USB port of the computer 12. As described above, the joystick 24 customarily has two dimensions of movement, up and down and left and right. Here, the first is used to control instant tempo over a particular range, left and right is used to control instant loudness. By moving the joystick 24 at an angle, a combination of tempo change and loudness change is produced. For example, upward left produces faster and louder, down and right slower and softer. The manner of use is not only as a sectional control of the music, i.e., of effects spread over several bars, which we shall call longer term effects, but also for immediate effect within small fractions of a second.

For example, a short jab to the upper right region causes an acceleration of the music lasting a small faction of a second, perhaps as short as a quarter of even a short note. A fast retrieval of the joystick 24 to near its previous position results in an accent produced on the note due not only to the louder portion of this transient, but also due to the acceleration of that fraction of the note, which in effect changes its rise time, thus producing an accent of its own, apart from the loudness effect. By choosing a suitable angle of movement, various types of accent, and even timbrual effects, due to shape changes, can be produced. The effect of this is spread across all instruments playing at that moment. A user can vary the angle of the joystick 24 at will from one moment or beat to the next and provide different kinds of accent thereby. In music history, “accent” is accounted for either by increased loudness and by increased duration of note (as for example, in organ playing), or a combination thereof.

Conducting different music with the instant rehearseless conducting process 100, one discovers certain movement patterns that suit different music. For example the music of Brahms elicits an elliptical movement pattern, whereas that of Mozart may occasion movements more linear movements. Different composers provide an unwritten fine structure to their music, which we call pulse, and includes a combined amplitude and time warp, so that four equal notes as written in the score, such as four sixteenth notes, are not played equally, but according to this defined amplitude and time warp, which in some manner corresponds to the personality of the composer.

It appears that the movement pattern used in conducting with joystick 24 may well be related to the particular time and amplitude warp within a beat or bar, and appears to be specific for that composer. Superimposed on such rapid oscillatory movements, there are longer term displacements, which correspond to larger scale changes in loudness and in tempo of the music. It is one advantage of the joystick 24 use however that it has an inbuilt neutral position to which it always returns, when released from grip. This makes it readily possible to use music files, such as the SuperConductor .msc files from MicroSound International Ltd. of Sonoma, Calif. 95476, which are pre-interpreted and can use joystick 24 conducting to provide additional subtleties and intimacy not present in the already, no matter how well, interpreted music. Musical Instrument Digital Interface (MIDI) files can be conducted by them into SuperConductor files. In one particular example, conducting of music from CDs, DVDs and Mp3s uses tempo transforming technology without change of pitch.

Movements of the joystick 24 are recorded on the storage device 22 as a series of numbers representing the instantaneous position of the joystick 24. A conducted version of the music can be saved and played back at any time. In one particular example, conducted music is saved as a Superconductor .msc file (or .wav file) and played through SuperConductor.

The instant rehearseless conducting process 100 enables an ability to correct mistakes made in conducting. This is done by playing back the saved conducted version of the music on, for example, SuperConductor. When the faulty part of the music is reached, one can simply start conducting again. The instant rehearseless conducting process 100 erases the previous conducted version of the part being newly conducted, and replaces it with the newly conducted version. All other parts remain unchanged. The instant rehearseless conducting process 100 can also be used in a loop mode so that a given portion of the music is conducted over again several times and then one can choose the best version.

In the SuperConductor program, the changes in tempo and in loudness are recorded as a series of numbers going to the tempo control as seen on the tempo slider and on the loudness slider respectively. One can see the sliders move up and down as one conducts. These multiple conducting changes are recorded in a tempo file in addition to the already present tempo indications, ritards and accelerandos already present. Such a micro-conducting file may contain many thousands of numbers for one piece of music, many times more than the unconducted but interpreted file.

One can also see the composer's score on the screen of Superconductor as one is conducting, and a red pointer moves on the score to show what bar is playing and it automatically turns the pages.

While instant rehearseless conducting process 100 has been described in the context of conducting an orchestra, instant rehearseless conducting process 100 can be applied to chamber music or piano music. In the latter, even single notes can be altered in loudness contour, and in timing, after they have been struck, an unimagined but very fruitful addition to piano music. A similar ability is given to guitar music and harpsichord.

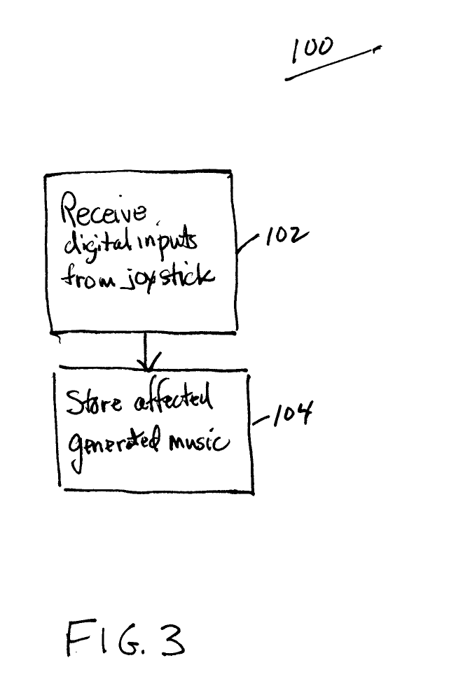

As shown in FIG. 3, the instant rehearseless conducting process 100 includes receiving (102) digital inputs from a joystick linked to a computer causing affects to music generated from a first music file and storing (104) the affected generated music in a second music file. The digital inputs include movements resulting positioning the joystick. The movements include up and down movements of the joystick controlling instant tempo over a particular range, and left and right movements of the joystick controlling instant loudness.

The movements include angled movements of the joystick controlling tempo change and loudness change. The angled movements of the joystick include an upward left movement of the joystick producing faster and louder music, and a downward right movement of the joystick producing slower softer music.

The movements include a short jab of the joystick to an upper right region producing an acceleration of the music, and a fast retrieval of the joystick near a previous position controlling an accent produced on a note due to a louder portion of this transient.

The movements include angled movements controlling accent of the music.

Storing (104) the affected generated music includes storing in an audio file. The audio file is selected from the group consisting of a Waveform audio format (WAV) file, a Musical Instrument Digital Interface (MIDI) file and a Superconductor (MSC) file.

Embodiments of the invention can be implemented in digital electronic circuitry, wireless technologies, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method comprising:
conducting music generated by a computer with a joystick.

2. The method of claim 1 in which the conducting comprises:
receiving digital inputs from the joystick causing affects to the generated music; and
storing the affected generated music.

3. The method of claim 2 in which the digital inputs comprise movements resulting positioning the joystick.

4. The method of claim 3 in which the movements comprise:
up and down movements of the joystick controlling instant tempo over a particular range; and
left and right movements of the joystick controlling instant loudness.

5. The method of claim 4 in which the movements comprise angled movements of the joystick controlling tempo change and loudness change.

6. The method of claim 5 in which the angled movements of the joystick comprise:
an upward left movement of the joystick producing faster and louder music; and
a downward right movement of the joystick producing slower softer music.

7. The method of claim 4 in which the movements comprise a short jab of the joystick to an upper right region producing an acceleration of the music.

8. The method of claim 4 in which the movements comprise a fast retrieval of the joystick near a previous position controlling an accent produced on a note due to a louder portion of this transient.

9. The method of claim 4 wherein the movements comprise angled movements controlling accent of the music.

10. The method of claim 2 in which storing the affected generated music comprises storing in an audio file.

11. The method of claim 10 in which the audio file is selected from the group consisting of: a Waveform audio format (WAV) file, a Musical Instrument Digital Interface (MIDI) file and a Superconductor (MSC) file.

12. A method comprising:
receiving digital inputs from a joystick linked to a computer causing affects to music generated from a first music file; and
storing the affected generated music in a second music file.

13. The method of claim 12 in which the digital inputs comprise movements resulting positioning the joystick.

14. The method of claim 13 in which the movements comprise:
up and down movements of the joystick controlling instant tempo over a particular range; and
left and right movements of the joystick controlling instant loudness.

15. The method of claim 14 in which the movements comprise angled movements of the joystick controlling tempo change and loudness change.

16. The method of claim 15 in which the angled movements of the joystick comprise:
an upward left movement of the joystick producing faster and louder music; and
a downward right movement of the joystick producing slower softer music.

17. The method of claim 14 in which the movements comprise a short jab of the joystick to an upper right region producing an acceleration of the music.

18. The method of claim 14 in which the movements comprise a fast retrieval of the joystick near a previous position controlling an accent produced on a note due to a louder portion of this transient.

19. The method of claim 14 wherein the movements comprise angled movements controlling accent of the music.

20. The method of claim 12 in which storing the affected generated music comprises storing in an audio file.

21. The method of claim 20 in which the audio file is selected from the group consisting of: a Waveform audio format (WAV) file, a Musical Instrument Digital Interface (MIDI) file and a Superconductor (MSC) file.
